(19) United States
(12) Patent Application Publication
(10) Pub. No.: US 2014/0011446 A1
(43) Pub. Date: Jan. 9, 2014

(54) Communications Connection

(71) Applicants: Mika P. Kangas, Oulu (FI); Jari J. Huhtamaki, Oulu (FI); Jaakko J. Rautiainen, Oulu (FI)

(72) Inventors: Mika P. Kangas, Oulu (FI); Jari J. Huhtamaki, Oulu (FI); Jaakko J. Rautiainen, Oulu (FI)

(73) Assignee: Nokia Corporation

(21) Appl. No.: 13/540,956

(22) Filed: Jul. 3, 2012

(51) Int. Cl. H04W 88/02; H04B 5/00; H04B 5/02

(52) U.S. Cl. 455/41.1; 455/575.7; 455/556.1; 455/552.1

(57) ABSTRACT

An apparatus including at least one coil; and electronic circuitry connected to the at least one coil. The electronic circuitry is configured to generate a magnetic field signal from the at least one coil. The magnetic field signal includes one or more data, where the magnetic field signal with the one or more data is configured to be used to create a wireless communication connection between the apparatus and a device.

### BACKGROUND

1. Technical Field

The exemplary and non-limiting embodiments of the invention relate generally to a wireless connection between two devices and, more particularly, to use of a magnetic field signal.

2. Brief Description of Prior Developments

BLUETOOTH is commonly used for wireless communication between an apparatus and an accessory device, such as between a mobile telephone and a headset for example. Mobile telephones commonly have a hearing aid compatibility (HAC) coil and HAC circuitry for inductive coupling with a hearing aid.

### SUMMARY

The following summary is merely intended to be exemplary. The summary is not intended to limit the scope of the claims.

In accordance with one aspect, an apparatus is provided including a coil; and electronic circuitry connected to the coil. The electronic circuitry is configured to generate a magnetic field signal from the coil. The magnetic field signal includes a wake-up signal and/or pairing information to subsequently create a separate wireless communications connection between the apparatus and a paired device.

In accordance with another aspect, an apparatus is provided comprising a first communications system comprising electronic circuitry and a coil, where the first communications system is configured to transmit a magnetic field signal by generating a magnetic field from the coil; and a second communications system comprising an antenna, where the second communications system is configured to transmit information from the antenna by radio frequency. The first communications system, by transmitting the magnetic field signal, is configured to at least partially pair the device with the apparatus. The second communications system is configured to subsequently provide a separate wireless communications connection with the device based at least partially upon pairing by the first communications system.

In accordance with another aspect, a method is provided comprising transmitting a magnetic field signal from a coil of an apparatus by a magnetic field, where the magnetic field signal comprises a wake-up signal for waking up a device and/or pairing information for pairing the apparatus with the device for subsequent radio frequency communication via a radio frequency link; and transmitting information by radio frequency from the apparatus via the radio frequency link, where the radio frequency link is established based at least partially upon the transmitting of the magnetic field signal from the coil.

In accordance with another aspect, a non-transitory program storage device readable by a machine, tangibly embodying a program of instructions executable by the machine, is provided where the operations comprise transmitting a magnetic field signal from a coil of an apparatus by a magnetic field, where the magnetic field signal comprises a wake-up signal for waking up a device and/or pairing information for pairing the apparatus with the device for subsequent radio frequency communication via a radio frequency link; and transmitting information by radio frequency from the apparatus via the radio frequency link, where the radio frequency link is established based at least partially upon the transmitting of the magnetic field signal from the coil.

### BRIEF DESCRIPTION OF THE DRAWINGS

The foregoing aspects and other features are explained in the following description, taken in connection with the accompanying drawings, wherein:

FIG. 1 is a front view of an example embodiment;

FIG. 2 is a block diagram illustrating components of the apparatus shown in FIG. 1;

FIG. 3 is a diagram illustrating communications between the apparatus shown in FIG. 1 and another device;

FIG. 4 is a diagram illustrating communications connection between the apparatus shown in FIG. 1 and a hearing aid;

FIG. 5 is a diagram illustrating communications between the apparatus shown in FIG. 1 and another device as in FIG. 3;

FIG. 6 is a diagram illustrating steps of an example method;

FIG. 7 is a diagram illustrating a signal sent from a coil of the apparatus shown in FIG. 1;

FIG. 8 is a diagram illustrating a resultant identification based upon the signal shown in FIG. 7;

FIGS. 9-12 are diagrams illustrating an example use scenario;

FIG. 13 is a diagram illustrating a coil as at least part of an antenna or charging coil; and

FIG. 14 is a diagram illustrating an alternate example embodiment.

### DETAILED DESCRIPTION OF EMBODIMENTS

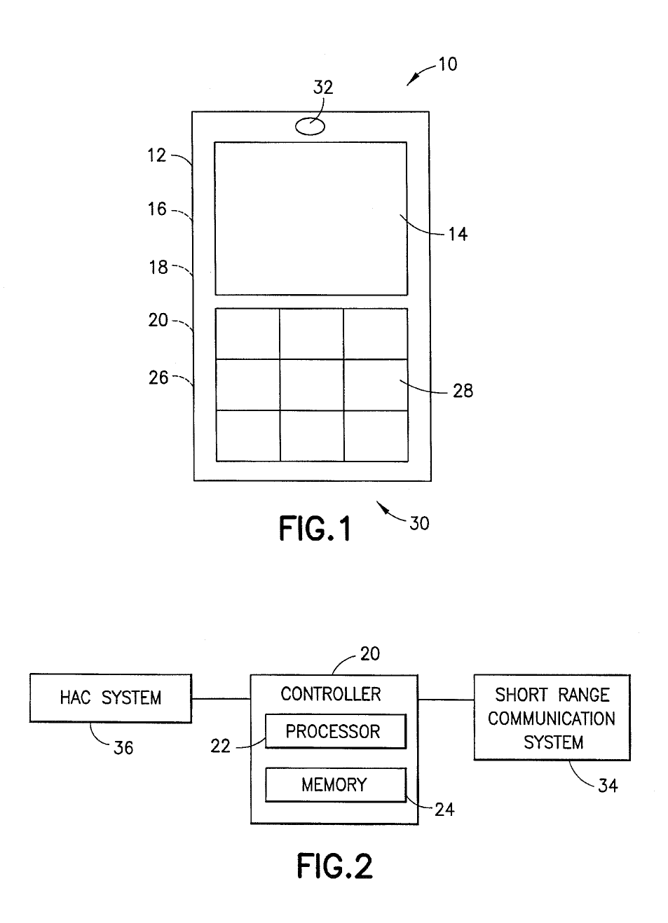

Referring to FIG. 1, there is shown a front view of an apparatus 10 incorporating features of an example embodiment. Although the features will be described with reference to the example embodiments shown in the drawings, it should be understood that features can be embodied in many alternate forms of embodiments. In addition, any suitable size, shape or type of elements or materials could be used.

The apparatus 10 may be a hand-held communications device which includes a telephone application. The apparatus 10 may also comprise an Internet browser application, camera application, video recorder application, music player and recorder application, email application, navigation application, gaming application, and/or any other suitable electronic device application. Referring to both FIGS. 1 and 2, the apparatus 10, in this example embodiment, comprises a housing 12, a display 14, a receiver 16, a transmitter 18, a rechargeable battery 26, and a controller 20 which can include at least one processor 22, at least one memory 24, and software. However, all of these features are not necessary to implement the features described below.

The display 14 in this example may be a touch screen display which functions as both a display screen and as a user input. However, features described herein may be used in a display which does not have a touch, user input feature. The user interface may also include a keypad 28. However, the keypad might not be provided if a touch screen is used. The electronic circuitry inside the housing 12 may comprise a printed wiring board (PWB) having components such as the controller 20 thereon. The circuitry may include a sound transducer 30 provided as a microphone and a sound transducer 32 provided as a speaker or earpiece.

The receiver 16 and transmitter 18 form a primary communications system to allow the apparatus 10 to communicate with a wireless telephone system, such as a mobile telephone base station for example. As shown in FIG. 2, in addition to the primary communications system 16, 18, the apparatus 10 also comprises a short range communications system 34. This short range communications system 34 comprises an antenna, a transmitter and a receiver for wireless radio frequency communications. The range may be, for example, only about 30 feet (10 meters) or less. However, the range might be as much as 60 feet (20 meters) for example.

The short range communications system 34 may use short-wavelength radio transmissions in the ISM band, such as from 2400-2480 MHz for example, creating personal area networks (PANs) with high levels of security. This may be a BLUETOOTH communications system for example. The short range communications system 34 may be used, for example, to connect the apparatus 10 another device, such as an accessory headset, a mouse, a keyboard, a display, an automobile radio system, or any other suitable device. An example is shown in FIG. 3 where the apparatus 10 is shown with a BLUETOOTH chip 40. The BLUETOOTH chip 40 comprises the short range transmitter, receiver and antenna. In the example shown in FIG. 3, the device 42 is a headset having a BLUETOOTH chip 40. A short range digital wireless communication link 44 may be established between the two chips 40.

As seen in FIG. 2, the apparatus 10 also comprises a Hearing Aid Compatibility (HAC) system 36. A Hearing Aid Compatibility (HAC) system is a system to interconnect a phone magnetically into a hearing aid device. In the past, a telecoil or T-coil of the HAC system was mounted inside both the hearing aid and the audio device such as the telephone handset. It allowed the magnet field signals to be coupled from the phone to the hearing aid without a wired electrical connection and it avoids the problems that microphones would have with the amplification of background noise.

A telecoil may be an induction coil. Placed in an alternating magnetic field, an alternating electrical current is “induced” in the coil. Reciprocally, an electrical current in coil creates a tiny magnetic field around it. The coil in the hearing aid 41 converts (changes) magnetic energy to electrical energy, in much the same way that a microphone converts sounds waves to electrical energy. Generally, the strength of the inductive pick-up may be determined by the number of turns of the coil. “T” coils may include an integrated amplifier, which makes it feasible to reduce the physical size of the “T” coil.

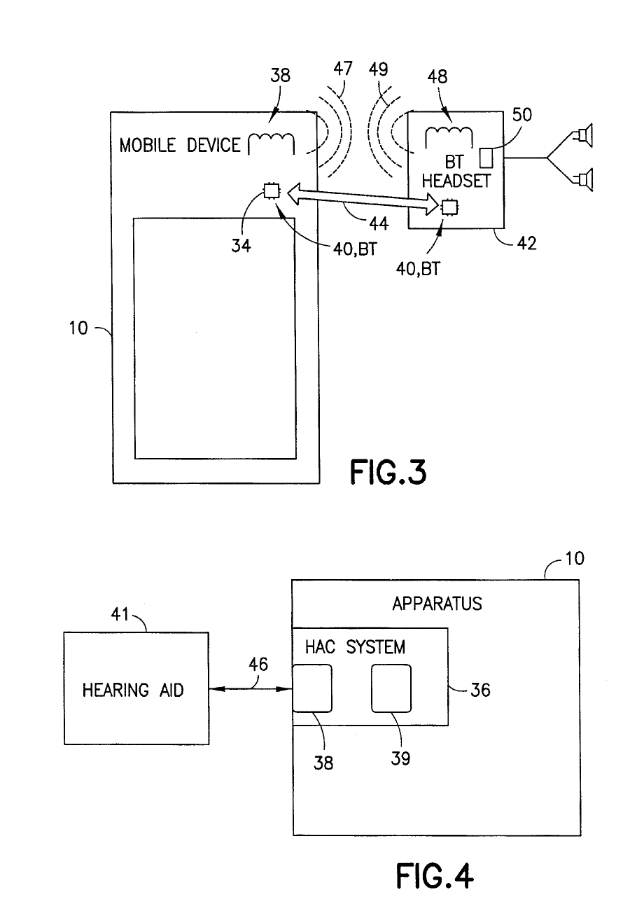

When a hearing aid is switched to the “T” position, the telecoil may be set to detect only an electromagnetic field. The strength of the electrical current “induced” in the telecoil by the electromagnetic field is directly proportional to both the energy in the magnetic field and to the relative positions of the induction coil in the hearing aid to the magnetic field (in a telephone or wire loop). As seen in FIG. 4, the user can hold the phone 10 up to his/her ear at the hearing aid 41 to allow magnetic field signals 46 from the coil 38 to be received by the telecoil in the hearing aid 41. Audio signals are sent to the coil 38 by the HAC electronic circuitry 39.

As seen in FIG. 3, the device 42 also comprises a coil 48. The device 42 has electronic circuitry 50 connected to the coil 48. The coil 48 and circuitry 50 are configured to allow wireless communication between the apparatus 10 and the device 42 via induction at the coils 38, 48 using magnet field signals.

In the past, creating pairing (such as BLUETOOTH pairing for example) between an apparatus and another device (such as an accessory device for example) required multiple stages before getting the connection done. In smartphones, Near Field Communication (NFC) has been introduced in many of the accessories to improve the usability and make the BLUETOOTH pairing as easy as possible. The NFC is used to initiate the BLUETOOTH pairing. NFC is normally provided via its own chipset which includes an antenna. The Near Field Communication Forum (NFC Forum) formed in 2004 promotes sharing, pairing, and transactions between NFC devices and develops and certifies device compliance with NFC standards. A smartphone or tablet with an NFC chip could make a credit card payment or serve as keycard or ID card. NFC devices can read NFC tags on a museum or retail display to get more information or an audio or video presentation. NFC can share a contact, photo, song, application, or video or pair Bluetooth devices. NFC is a set of short-range wireless technologies, typically requiring a distance of 4 cm or less. NFC operates at 13.56 MHz on ISO/IEC 18000-3 air interface and at rates ranging from 106 kbit/s to 424 kbit/s. NFC always involves an initiator and a target; the initiator actively generates an RF field that can power a passive target. This enables NFC targets to take very simple form factors such as tags, stickers, key fobs, or cards that do not require batteries. NFC peer-to-peer communication is of course possible, where both devices are powered.

However, not all phones are desired to have a NFC chipset. For example, less expensive Entry and Feature phones (i.e., non-smartphones) might not be provided with a NFC chipset in order to reduce manufacturing costs and keep the costs of the phones inexpensive. Adding NFC to phones increases costs quite a lot, and has been a deterrent to NFC deployment. Features as described herein may enable a usability similar to NFC, which is easy to use, and with a relatively low manufacturing cost.

One feature as described herein is to use the standard (HAC) coil, already present in designs of current mobile telephones, in data communication providing a similar set of functionality to what NFC does. Thus, in addition to using the HAC coil for audio listening purposes with a hearing aid, the HAC coil may be used as a mean for short range data connection similar to NFC communications. Features described herein are not limited using a HAC coil for this purpose. Anything that is able to provide a strong enough magnetic field around it, and acts the same way that a normal induction coil functions, could be used as the coil for the substitute near field communication system or quasi-NFC system 52.

Main components that may be used to enable features are the HAC coil 38, a coil 48 in the device 42, the apparatus 10 having electronic circuitry 54 for quasi-NFC features (for using the HAC coil 38 for sending a wake-up signal and/or sending/receiving pairing information for example), and the electronic circuitry 50 in the device 42 for receiving a wake-up signal and/or sending/receiving pairing information. The example described herein uses technology with a BLUETOOTH accessory, but it is not limited to BLUETOOTH accessories.

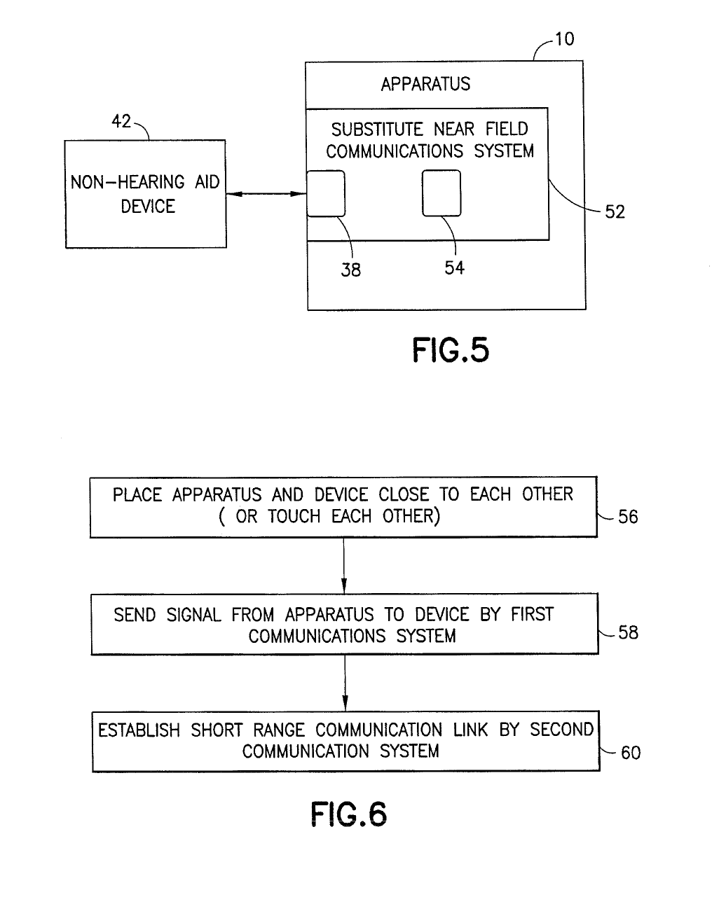

Referring also to FIG. 6, an example method may comprises placing the apparatus 10 and the device 42 in close proximity to each other, or perhaps touch each other as indicated by block 56. The coil 38 may then be used to send a signal 47 (see FIG. 3) to the coil 48 of the device 42 as a first communications system as indicated by block 58. The signal 47 may be by means of analog magnetic field variations. After the coil 48 receives the signal 47, the circuitry 50 may be configured at least partially help establish a second different communications link 44 as illustrated by block 60 via the short range communication system 34, such as with BLUETOOTH chips 40 for example. As seen in FIG. 3, the coil 48 may be used to send a signal 49 back to the coil 47.

There are different possible methods of using the two communication system noted above. In a first type of method, the signal 47 could be used to wake up the device 42, and the device using the signal 49 to transmit pairing information back to the apparatus 10. In a second type of method, the apparatus 10 and device 42 might already be bonded to each other (pairing occurred previously) but the device 42 is not awake. The signal 47 might merely be a wake-up signal. In a third type of method, the device 42 might already be awake and the signal 47 could comprise pairing information. These are merely non-limiting examples.

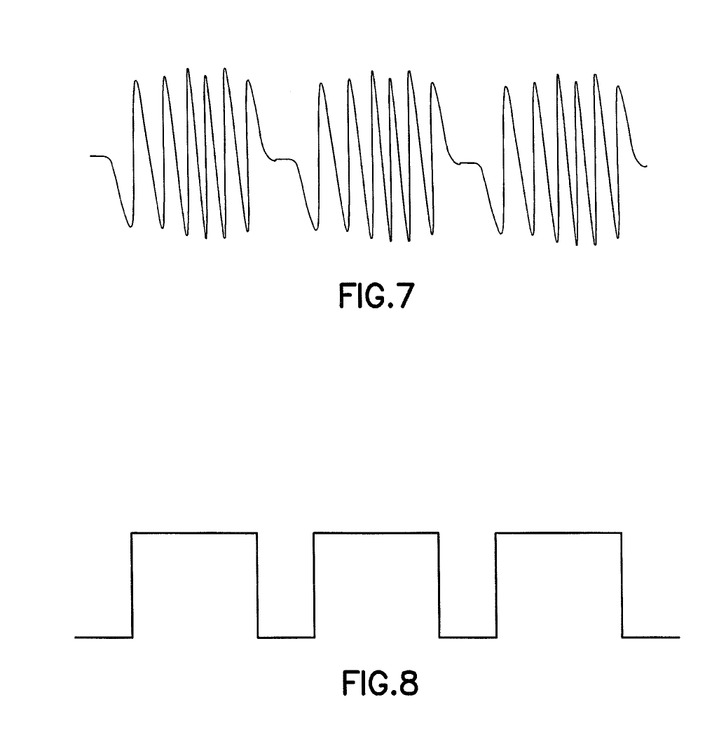

In one type of example the signal 47 may comprise a wake-up signal to wake up the device 42. For example, referring also to FIGS. 7 and 8, the HAC coil may be powered to cause a magnetic field within short range having the signal 47. When the user locates his/her apparatus 10 close to the device 42 this will cause the coil 48 in device 42 to be under the apparatus' magnetic field fluctuations as seen in FIG. 7. This may initiate a voltage raise in device 42 from the coil 48, and recognition of the signal 47 may work as an initiation for the device 42 to power up from idle. With the device 42 now awake, the wake-up pulse from the signal 47, as shown in FIG. 8 corresponding to FIG. 7, may be used to identify or verify the wake-up situation. After wake up, the pairing information via the signal 49 may be sent to the apparatus 10 using the same type of modulation mechanism via the coils 38, 48.

The HAC coil is not used for Near Field Communications (which uses radio frequency transmissions). Instead, the HAC coil is used as a quasi-NFC using magnetic field signals; not radio frequency signals. This can create a same type of user experience for accessory pairing that one would be able to have with NFC enabled BLUETOOTH headsets, but much less expensive to manufacture because no NFC chipset is needed.

Features as described herein may be used to provide an easy way to pair a normal BLUETOOTH headphone/device 42 to a BLUETOOTH enabled phone 10. This mimics the same functionality that NFC provides, but with less cost. This is different than using the HAC for audio transmission between the devices, but instead merely uses the HAC coil to initiate the pairing between devices via a first communications system 52 (Substitute NFC system), and once pairing is done a second communications system 34 (such as BLUETOOTH for example) can be used for further communications between the devices. NFC is an expensive and challenging implementation. Therefore, it is difficult to implement NFC and its functionality into low-end products. With features as described herein, a new method and implementation may be provided for connecting BLUETOOTH devices effortlessly to master devices like mobile phones or other BLUETOOTH enabled devices using an internal coil (such as a HAC coil for example). It could be considered as ‘Touch and Connect’ functionality in a cheap and easy manner.

Advantages include cheap and easy connectivity; shared usage of an internal component like a HAC coil; and mechanically less challenging to design. One idea is to imitate the NFC functionality with relatively low price components to enable the similar functionality in Entry/Feature phones as well. This may be used for easy BLUETOOTH pairing between a mobile device and a BLUETOOTH headset for example.

In one type of use situation the initial states would be that the BLUETOOTH feature is OFF in the device 42 and the HAC coil 38 would be active only while the key/touch lock is OFF and display is ON. When this is the case, the HAC coil 38 is powered ON for possible connection to the device 42. When creating the BLUETOOTH connection the HAC coil is used to initiate the pairing.

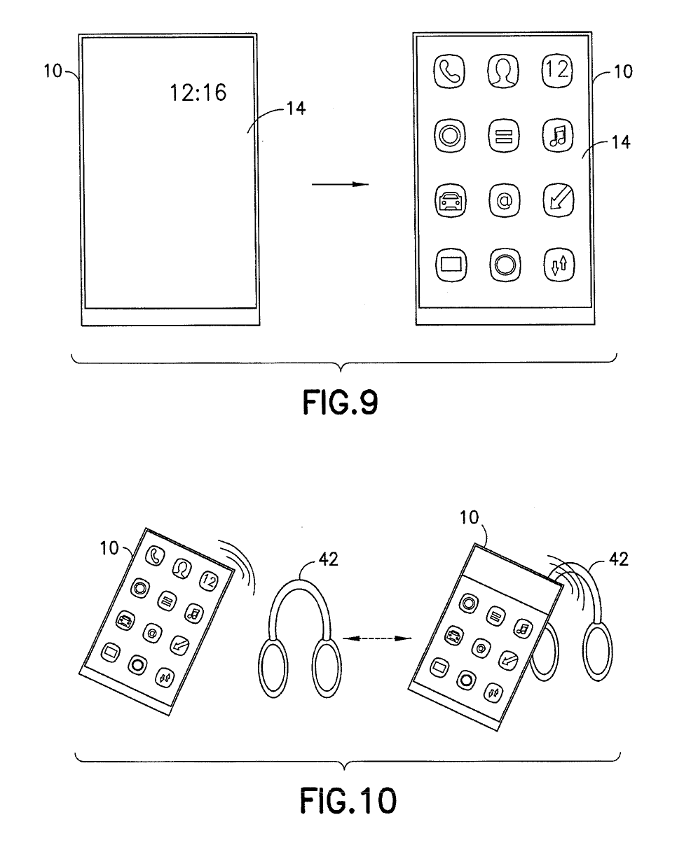

Referring also to FIG. 9, in this example use the apparatus 10 is initially idle, and the coil 38 is not active (not powered). When the user activates the display screen, the HAC coil is automatically powered and will cause a magnetic field within short range. As seen in FIG. 10, when the user takes his/her apparatus 10 close to device 42, this will cause the coil 48 in device 42 to be under the influence of the magnetic field from the coil 38 of the apparatus 10. This may initiate a voltage raise in device 42 and work as an initiation for the device 42 to power up from idle. Once the device 42 is active, the coils 38, 48 may be used to send and receive the ID properties for both the apparatus 10 and the device 42 for the short range communications system link 44 (such as BLUETOOTH for example) to be able to create the pairing automatically. In other words, the user places the apparatus 10 and device 42 next to each other to initiate a Coil connection, and to wake up the accessory 42; applying the magnetic field on top of the accessories coil. During the coil connection, BLUETOOTH details are exchanged and may be used to start the BLUETOOTH pairing. In one example, during the coil connection the BLUETOOTH details are being sent during the current connection. In another example, during the coil connection the BLUETOOTH details are used which have been earlier exchanged.

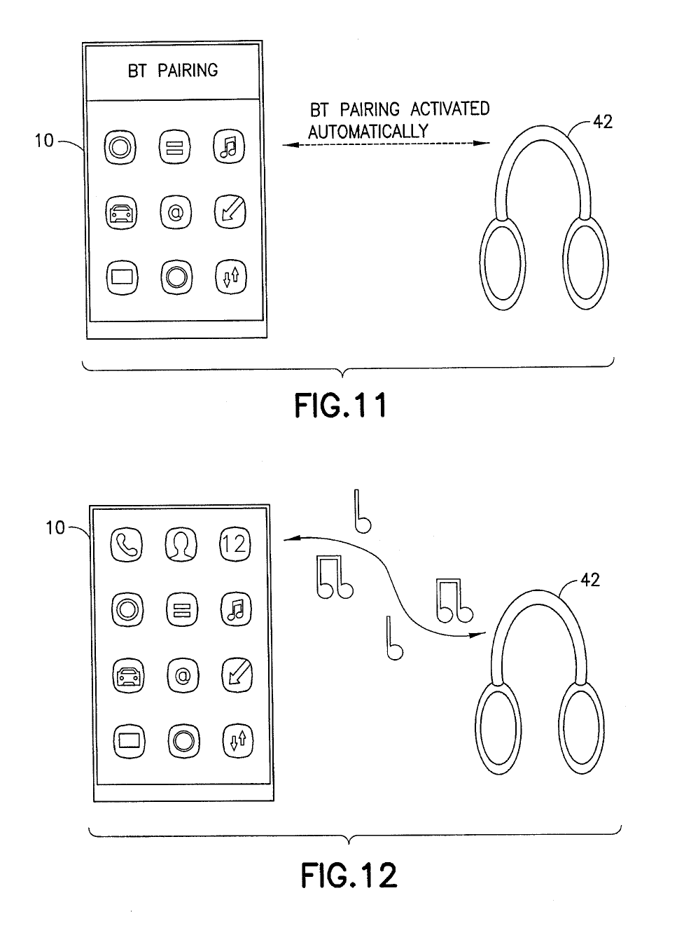

Referring also to FIG. 11, the apparatus 10 and the device 42 create the short range communications link 44 using the credentials received from the first communications connection with the earlier exchanged short range communication system IDs. The pairing and ID information may be transferred only once when the quasi-NFC connection is made for the first time. The quasi-NFC communication could be some frequency pulsing (similar to IR remote controls). As shown in FIG. 12, the link 44 is then used without further use of the coils 38, 48. It should be understood that the “coil” connection might not have two way communication. Referring back to FIG. 3, in one type of example, a system may be provide where only one way communication is needed via the “coil” connection, such as providing only signal 47 without the need to provide signal 49 (or vice versa) for example.

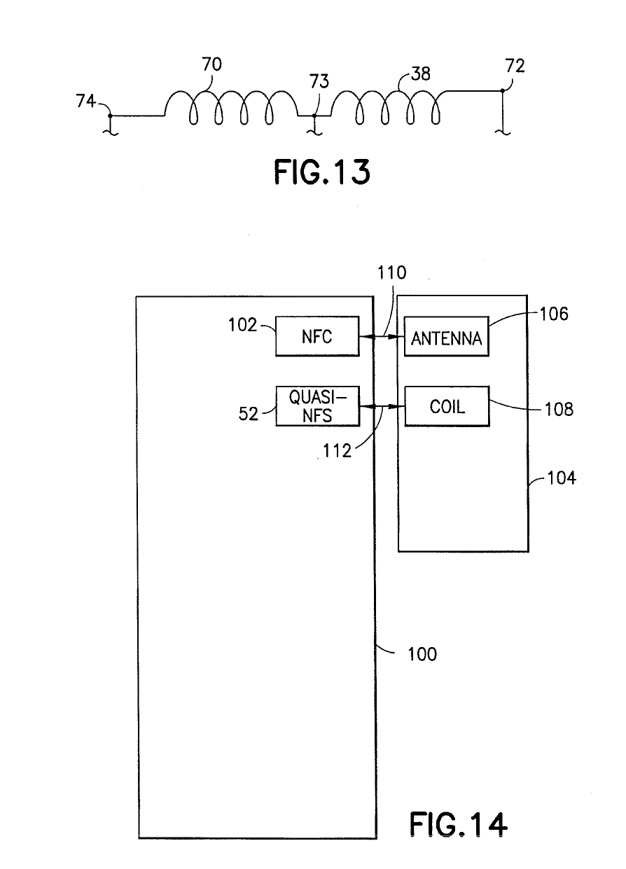

Referring also to FIG. 13, the coil 38 used for the quasi-NFC system 52 may be at least part of an antenna or charging coil 70 with different feed points 72, 73, 74. As other examples, the coil(s) could comprise the coil of a speaker component, a dedicated coil, a touchscreen coil, or any other suitable coil.

One type of example embodiment may be provided in an apparatus 10 comprising a coil 38; and electronic circuitry 54 connected to the coil, where the electronic circuitry is configured to generate a magnetic field signal 47 from the coil, where the magnetic field signal comprises a wake-up signal and/or pairing information to subsequently create a separate wireless communications connection 44 between the apparatus 10 and a paired device 42.

The coil 38 may be at least a portion of a hearing aid compatibility (HAC) coil. The coil may be at least a portion of an antenna. The coil may be at least a portion of an induction charging coil. The electronic circuitry may comprise hearing aid compatibility (HAC) electronic circuitry. The wake-up signal may comprise a wake-up pulsed signal. The pairing information may comprise ID properties of the apparatus for pairing the apparatus with the paired device. The apparatus may comprise a first communications system comprising the electronic circuitry and the coil; and a second communications system comprising an antenna, where the second communications system is configured to transmit information from the antenna to an antenna of the device by radio frequency. The apparatus may be a mobile telephone.

One type of example embodiment may be provided in an apparatus 42 comprising a coil 48; and electronic circuitry 50 connected to the coil, where the electronic circuitry is configured to generate a magnetic field signal 49 from the coil, where the magnetic field signal comprises pairing information to subsequently create a separate wireless communications connection 44 between the apparatus 42 and a paired device 10.

One type of example embodiment may be provided in an apparatus 10 comprising a first communications system 52 comprising electronic circuitry 54 and a coil 38, where the first communications system is configured to transmit a magnetic field signal 47 by generating a magnetic field from the coil; and a second communications system 34 comprising an antenna, where the second communications system is configured to transmit information from the antenna by radio frequency, where the first communications system 52, by transmitting the magnetic field signal, is configured to at least partially pair the device 42 with the apparatus 10, and where the second communications system 34 is configured to subsequently provide a separate wireless communications connection with the device based at least partially upon pairing by the first communications system 52.

The coil may be at least a portion of a hearing aid compatibility (HAC) coil. The coil may be at least a portion of an induction charging coil. The coil may be at least a portion of the antenna. The electronic circuitry may comprise hearing aid compatibility (HAC) electronic circuitry. The second communications system may be configured to transmit digital radio frequency signals. The magnetic field signal may be an analog signal. The magnetic field signal may comprise a pulsed wake-up signal. The pairing information may comprise ID properties of the apparatus for pairing the apparatus with the paired device.

An example method may comprise transmitting a magnetic field signal 47 from a coil 38 of an apparatus 10 by a magnetic field, where the magnetic field signal comprises a wake-up signal for waking up a device and/or pairing information for pairing the apparatus with the device for subsequent radio frequency communication via a radio frequency link 44; and transmitting information by radio frequency from the apparatus via the radio frequency link 44, where the radio frequency link 44 is established based at least partially upon the transmitting of the magnetic field signal from the coil. The coil may be a hearing aid compatibility (HAC) coil such that the magnetic field signal is transmitted from the HAC coil. The pairing information may comprise ID properties of the apparatus for pairing the apparatus with the device.

In one example, a non-transitory program storage device 24 may be provided readable by a machine, tangibly embodying a program of instructions executable by the machine, the operations comprising transmitting a magnetic field signal from a coil of an apparatus by a magnetic field, where the magnetic field signal comprises a wake-up signal for waking up a device and/or pairing information for pairing the apparatus with the device for subsequent radio frequency communication via a radio frequency link; and transmitting information by radio frequency from the apparatus via the radio frequency link, where the radio frequency link is established based at least partially upon the transmitting of the magnetic field signal from the coil.

Features as described herein may be used to replace NFC; not necessarily for only use in pairing two devices. As described further below, features as described herein may alternatively be used to supplement NFC communications; thus having both NFC and quasi-NFC communications (the above described magnetic field signaling) at the same time.

Near field communication, or NFC, allows for simplified transactions, data exchange, and wireless connections between two devices in close proximity to each other, usually by no more than a few centimeters. Many smartphones currently on the market already contain embedded NFC chips that can send encrypted data a short distance (“near field”) to a reader located, for instance, next to a retail cash register. Shoppers who have their credit card information stored in their NFC smartphones can pay for purchases by waving their smartphones near or tapping them on the reader, rather than bothering with the actual credit card.

NFC tags contain data and are typically read-only, but may be rewriteable. They can be custom-encoded by their manufacturers or use the specifications provided by the NFC Forum, an industry association charged with promoting the technology and setting key standards. The tags can securely store personal data such as debit and credit card information, loyalty program data, PINs and networking contacts, among other information. The NFC Forum defines four types of tags which provide different communication speeds and capabilities in terms of configurability, memory, security, data retention and write endurance. Tags currently offer between 96 and 512 bytes of memory.

As with proximity card technology, near-field communication uses magnetic induction between two loop antennas located within each other's near field, effectively forming an air-core transformer. It operates within the globally available and unlicensed radio frequency ISM band of 13.56 MHz. Most of the RF energy is concentrated in the allowed 14 kHz bandwidth range, but the full spectral envelope may be as wide as 1.8 MHz when using ASK modulation. Theoretical working distance of a near field communication system with a compact standard antennas is up to 20 cm, but with a practical working distance of about 4 centimeters.

There are two modes:
Passive communication mode: The initiator device provides a carrier fields and the target device answers by modulating the existing field. In this mode, the target device may draw its operating power from the initiator-provided electromagnetic field, thus making the target device a transponder.
Active communication mode: Both initiator and target device communicate by alternately generating their own fields. A device deactivates its RF field while it is waiting for data. In this mode, both devices typically have power supplies.

NFC employs two different codings to transfer data. If an active device transfers data at 106 kbit/s, a modified Miller coding with 100 percent modulation can be used. In all other cases Manchester coding can be used with a modulation ratio of 10 percent. NFC devices are able to receive and transmit data at the same time. Thus, they can check for potential collisions if the received signal frequency does not match with the transmitted signal's frequency.

Features as described herein may be used to completely replace NFC and/or supplement NFC as a different communications link, perhaps at a same time as NFC. An example is shown in FIG. 14 where an apparatus 100 comprises both a NFC feature 102 and the quasi-NFC system 52. The device 104 comprises an antenna 106 to communicate with the antenna of the NFC system 102 and a coil 106 to communicate with the quasi-NFC system 52. The link 108 is a radio frequency NFC communication. The link 110 is a magnetic field signal communication. Thus, when the apparatus 100 is placed in close proximity or touches the device 104, either one or both of the links 110, 112 can be used to transmit and receive information or signals between the two devices 100, 104. Thus, the quasi-NFC system 52 may perhaps supplement the NFC system 102.

In one example, an apparatus 10 is provided comprising at least one coil 38; and electronic circuitry 54 connected to the at least one coil, where the electronic circuitry is configured to generate a magnetic field signal 47 from the at least one coil, where the magnetic field signal comprises one or more data, where the magnetic field signal with the one or more data is configured to be used to create a wireless communication connection 44 between the apparatus and a paired device 42.

In one example, an apparatus 10 is provided comprising a first communications system 52 comprising electronic circuitry 54 and at least one coil 38, where the first communications system is configured to transmit a magnetic field signal 47 by generating a magnetic field from the at least one coil; and a second communications system 34 comprising an antenna, where the second communications system is configured to transmit information from the antenna by radio frequency, where the first communications system, by transmitting the magnetic field signal, is configured to at least partially pair a device 42 with the apparatus 10, and where the second communications system is configured to subsequently provide a wireless communications connection 44 with the device based at least partially upon pairing by the first communications system.

In one example, a method is provided comprising transmitting a magnetic field signal 47 from at least one coil 38 of an apparatus 10 by a magnetic field, where the magnetic field signal comprises one or more data, where the magnetic field signal with the one or more data is configured to be used to create a wireless communication connection 44 between the apparatus 10 and a device 42; and transmitting information by radio frequency from the apparatus via the wireless communication connection, where the wireless communication connection is established based at least partially upon the transmitting of the magnetic field signal from the at least one coil.

In one example a non-transitory program storage device 24 readable by a machine is provided, tangibly embodying a program of instructions executable by the machine, the operations comprising transmitting a magnetic field signal from at least one coil of an apparatus by a magnetic field, where the magnetic field signal comprises one or more data, where the magnetic field signal with the one or more data is configured to be used to create a wireless communication connection between the apparatus and a device; and transmitting information by radio frequency from the apparatus via the wireless communication connection, where the wireless communication connection is established based at least partially upon the transmitting of the magnetic field signal from the at least one coil.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
at least one coil; and
electronic circuitry connected to the at least one coil, where the electronic circuitry is configured to generate a magnetic field signal from the at least one coil, where the magnetic field signal comprises one or more data, where the magnetic field signal with the one or more data is configured to be used to create a wireless communication connection between the apparatus and a device.

2. An apparatus as in claim 1 where the at least one coil is at least a portion of a hearing aid compatibility (HAC) coil.

3. An apparatus as in claim 1 where the at least one coil is at least a portion of an antenna.

4. An apparatus as in claim 1 where the at least one coil is at least a portion of an induction charging coil.

5. An apparatus as in claim 1 where the electronic circuitry comprises hearing aid compatibility (HAC) electronic circuitry.

6. An apparatus as in claim 1 where the one or more data comprises a wake-up signal and/or pairing information.

7. An apparatus as in claim 6 where the wake-up signal comprises a wake-up pulsed signal.

8. An apparatus as in claim 6 where the pairing information comprises ID properties of the apparatus for pairing the apparatus with the device.

9. An apparatus as in claim 1 where the apparatus comprises:
a first communications system comprising the electronic circuitry and the at least one coil; and
a second communications system comprising an antenna, where the second communications system is configured to transmit information from the antenna to an antenna of the device by radio frequency.

10. An apparatus as in claim 1 where the apparatus is a mobile telephone.

11. An apparatus comprising:
a first communications system comprising electronic circuitry and at least one coil, where the first communications system is configured to transmit a magnetic field signal by generating a magnetic field from the at least one coil; and
a second communications system comprising an antenna, where the second communications system is configured to transmit information from the antenna by radio frequency,
where the first communications system, by transmitting the magnetic field signal, is configured to at least partially pair a device with the apparatus, and where the second communications system is configured to subsequently provide a wireless communications connection with the device based at least partially upon pairing by the first communications system.

12. An apparatus as in claim 11 where the at least one coil is at least a portion of a hearing aid compatibility (HAC) coil.

13. An apparatus as in claim 11 where the at least one coil is at least a portion of an induction charging coil.

14. An apparatus as in claim 11 where the at least one coil is at least a portion of the antenna.

15. An apparatus as in claim 11 where the electronic circuitry comprises hearing aid compatibility (HAC) electronic circuitry.

16. An apparatus as in claim 11 where the second communications system is configured to transmit digital radio frequency signals.

17. An apparatus as in claim 16 where the magnetic field signal is an analog signal.

18. An apparatus as in claim 16 where the magnetic field signal comprises a pulsed wake-up signal.

19. An apparatus as in claim 11 where the magnetic field signal comprises pairing information including ID properties of the apparatus for pairing the apparatus with the device.

20. A method comprising:
transmitting a magnetic field signal from at least one coil of an apparatus by a magnetic field, where the magnetic field signal comprises one or more data, where the magnetic field signal with the one or more data is configured to be used to create a wireless communication connection between the apparatus and a device; and
transmitting information by radio frequency from the apparatus via the wireless communication connection, where the wireless communication connection is established based at least partially upon the transmitting of the magnetic field signal from the at least one coil.

21. A method as in claim 20 where the one or more data comprises a wake-up signal for waking up the device and/or pairing information for pairing the apparatus with the device for subsequent radio frequency communication via a radio frequency link.

22. A method as in claim 20 where the at least one coil is a hearing aid compatibility (HAC) coil such that the magnetic field signal is transmitted from the HAC coil

23. A method as in claim 21 where the pairing information comprises ID properties of the apparatus for pairing the apparatus with the device.

24. A non-transitory program storage device readable by a machine, tangibly embodying a program of instructions executable by the machine, the operations comprising:
transmitting a magnetic field signal from at least one coil of an apparatus by a magnetic field, where the magnetic field signal comprises one or more data, where the magnetic field signal with the one or more data is configured to be used to create a wireless communication connection between the apparatus and a device; and
transmitting information by radio frequency from the apparatus via the wireless communication connection, where the wireless communication connection is established based at least partially upon the transmitting of the magnetic field signal from the at least one coil.
